(19) United States
(12) Patent Application Publication
(10) Pub. No.: US 2015/0260674 A1
(43) Pub. Date: Sep. 17, 2015

(54) ELECTROCHEMICAL ANALYSIS AND SIMULATION DEVICE

(71) Applicant: Zensor R&D Company, Taichung City (TW)

(72) Inventor: Meng-Lan TSAO, Taichung City (TW)

(21) Appl. No.: 14/606,841

(22) Filed: Jan. 27, 2015

(30) Foreign Application Priority Data
Mar. 12, 2014 (TW) 103108836

(51) Int. Cl. G01N 27/28

(52) U.S. Cl. CPC G01N 27/28

(57) ABSTRACT

An electrochemical analysis and simulation device includes an input unit, a processing unit, a display unit and a power supply unit. The input unit is configured to read an executable program pre-written into a replaceable counting chip. The processing unit is electrically coupled to the input unit and configured to process an inspection signal of a sample according to the executable program to generate and inspection result. The display unit is electrically coupled to the processing unit and configured to display the inspection result. The power supply unit is electrically coupled to the processing unit and the display unit and configured to supply electric power required by the processing unit and the display unit.

### CROSS-REFERENCE TO RELATED APPLICATION

This application claims the benefit of Taiwan Patent Application No. 103108836, filed on Mar. 12, 2014, in the Taiwan Intellectual Property Office, the disclosure of which is incorporated herein its entirety by reference.

### FIELD OF THE INVENTION

The present invention relates to an electrochemical analysis and simulation device, and more particularly to the electrochemical analysis and simulation device capable of changing simulation parameters and executing an offline electrochemical simulation.

### BACKGROUND OF THE INVENTION

In general, an electrochemical analyzer is used to perform different inspections and analyses for various types of samples in order to determine the existence of one or more analytes in the sample. The conventional electrochemical analyzer usually displays and analyzes data by software preinstalled in a personal computer or a notebook computer, so that the volume of the electrochemical analyzer is large and unfavorable to carry, and the electrochemical analyzer must be connected to the personal computer or the notebook computer before performing an electrochemical analysis. Although portable electrochemical analyzer (such as blood glucose meters) has been developed, such electrochemical analyzer can inspect only one kind of analyte, and such application lacks flexibility of use.

### SUMMARY OF THE INVENTION

In view of the problems of the prior art, it is a primary objective of the present invention to provide an electrochemical analysis and simulation device capable of using a replaceable counting chip to edit various inspection parameters to inspect various types of analytes, and executing an offline electrochemical simulation without requiring a connection to a personal computer or a notebook computer, as well as featuring high portability to satisfy different types of inspection requirements.

To achieve the aforementioned objective, the present invention provides an electrochemical analysis and simulation device comprising an input unit, a processing unit, a display unit and a power supply unit. Wherein, the input unit is configured to read an executable program pre-written into a replaceable counting chip; the processing unit is electrically coupled to the input unit and configured to process an inspection signal of a sample according to the executable program to generate an inspection result; the display unit is electrically coupled to the processing unit and configured to display the inspection result; and the power supply unit is electrically coupled to the processing unit and the display unit and configured to supply electric power required by the processing unit and the display unit.

Preferably, the electrochemical analysis and simulation device further comprises a transmission unit electrically coupled to the processing unit and configured to access the inspection result. Wherein, the transmission unit is a wired transmission unit or a wireless transmission unit.

Preferably, the electrochemical analysis and simulation device further comprises a control unit electrically coupled to the processing unit and configured to control the processing unit to process the inspection signal of the sample.

Preferably, the electrochemical analysis and simulation device further comprises an indicating unit electrically coupled to the processing unit and power supply unit and configured to indicate a processing status of the inspection signal of the sample processed by the processing unit, and indicate an electric power status of the power supply unit.

Preferably, the electrochemical analysis and simulation device further comprises a storage unit electrically coupled to processing unit configured to store the inspection result.

Preferably, the electrochemical analysis and simulation device further comprises an inspection unit electrically coupled to the processing unit and configured to capture the inspection signal of the sample. Wherein, the inspection unit is a three-electrode system or a multi-electrode system.

Preferably, the input unit is an information recognition device.

Preferably, the power supply unit is a battery, a power cable coupled to a mains power supply, or a cable shared with a signal transmission cable.

Preferably, the electrochemical analysis and simulation device further comprises an environmental sensing unit electrically coupled to processing unit and configured to sense an environmental factor, so that the processing unit may correct the inspection signal according to the environmental factor to generate the inspection result.

Preferably, the environmental factor includes temperature, humidity, pressure, light intensity, oxygen content, pH value, salts content or any combination of the above.

In summation, the electrochemical analysis and simulation device of the present invention has one or more of the following advantages:

(1) The electrochemical analysis and simulation device of the present invention may not only be connected to a personal computer or a notebook computer to act as a conventional electrochemical analyzer, but also execute an offline electrochemical simulation to act as a portable electrochemical simulator.

(2) The electrochemical analysis and simulation device of the present invention uses a replaceable counting chip to edit different types of inspection parameters to inspect various types of analytes, so as to improve flexibility of use significantly.

(3) The electrochemical analysis and simulation device of the present invention may use an environmental sensing unit to correct the influence of the environment to the inspection result, so as to improve the precision of inspection.

(4) The electrochemical analysis and simulation device of the present invention may use a display unit to display an offline simulation result in real time, so as to improve convenience of use.

### BRIEF DESCRIPTION OF THE DRAWINGS

FIG. 1 is a schematic block diagram of an electrochemical analysis and simulation device in accordance with a preferred embodiment of the present invention;

FIG. 2 is a schematic view of an electrochemical analysis and simulation device in accordance with a preferred embodiment of the present invention;

FIG. 3 is a schematic view of an interface of an electrochemical analysis and simulation device which is used as an electrochemical analyzer in accordance with a preferred embodiment of the present invention; and

FIGS. 4 to 7 are schematic views of interfaces of an electrochemical analysis and simulation device which is used as an electrochemical simulator in accordance with a preferred embodiment of the present invention.

### DESCRIPTION OF THE PREFERRED EMBODIMENTS

The technical characteristics, contents, advantages and effects of the present invention will be apparent with the detailed description of a preferred embodiment accompanied with related drawings as follows. The drawings are provided for the illustration, and same numerals are used to represent respective elements in the preferred embodiments. It is intended that the embodiments and drawings disclosed herein are to be considered illustrative rather than restrictive. Same numerals are used for representing same respective elements in the drawings.

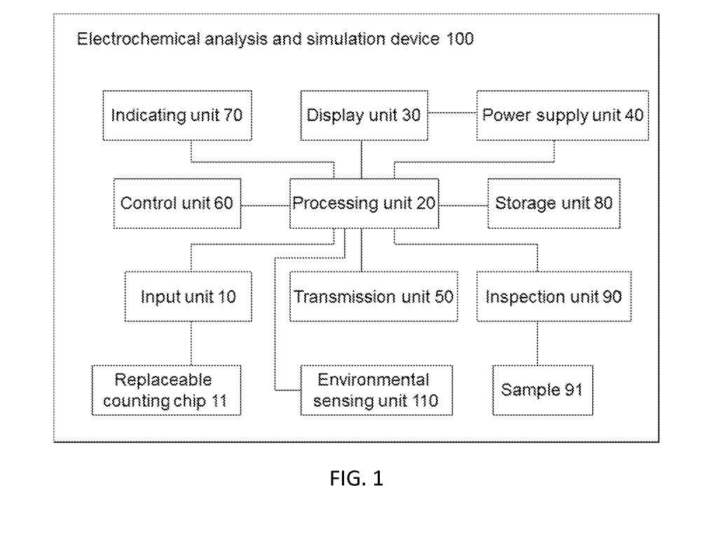

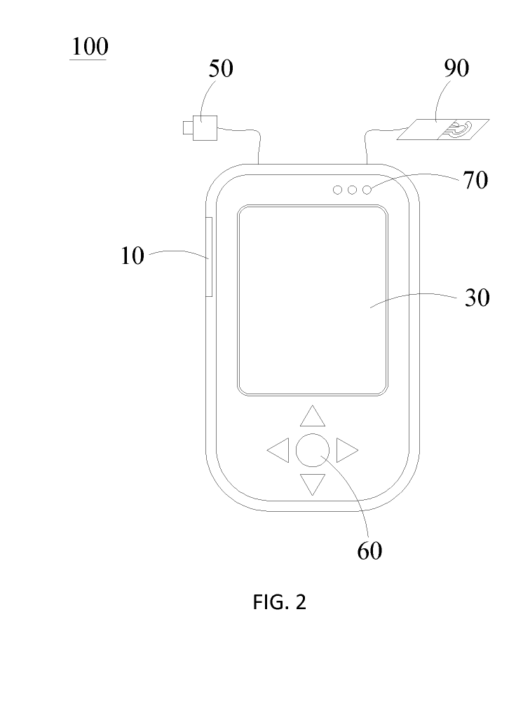

With reference to FIGS. 1 and 2 for a schematic block diagram and a schematic view of an electrochemical analysis and simulation device in accordance with a preferred embodiment of the present invention respectively, the electrochemical analysis and simulation device 100 comprises an input unit 10, a processing unit 20, a display unit 30 and a power supply unit 40. For simplicity, the processing unit 20 and the power supply unit 40 are not shown in FIG. 2.

The input unit 10 is configured to read an executable program pre-written into a replaceable counting chip 11. Wherein, the input unit 10 is an information recognition device including a socket, a chip reader, a memory reader or any reader built in or externally connected to the electrochemical analysis and simulation device 100.

The processing unit 20 is electrically coupled to the input unit 10 and configured to process an inspection signal of a sample 91 according to the executable program pre-written into the replaceable counting chip 11 to generate an inspection result. The processing unit 20 captures the inspection signal of the sample 91 by an inspection unit 90 electrically coupled to the processing unit 20, wherein the processing unit 20 may be a microprocessor or a microcontroller, and the inspection unit 90 may be a three-electrode system or a multi-electrode system. For example, the processing unit 20 may apply a voltage to the sample 91 through the inspection unit 90 so as to receive a current from the sample 91, and an electrochemical analysis method such as Cyclic Voltammetry (CV), Amperometry (I-T Curve), Square-Wave Voltammetry (SWV), Differential Pulse Voltammetry (DPV), or any combination of the above is used for the analysis to generate the inspection result such as the concentration of an analyte (including cholesterol, heavy metal or carbohydrate).

The display unit 30 is electrically coupled to the processing unit 20 and configured to display the inspection result. The display unit 30 may be a liquid crystal display (LCD), a light emitting diode (LED) display, an organic light emitting diode (OLED) display, a plasma display, a vacuum fluorescent display or a field emission display.

The power supply unit 40 is electrically coupled to the processing unit 20 and the display unit 30 and configured to supply the electric power required by the processing unit 20 and the display unit 30. The power supply unit 40 may be a battery, a power cable coupled to a mains power supply, or a cable shared with a signal transmission cable, and the battery may be a lithium battery, a secondary lithium battery, a polymer lithium battery, a mercury battery, a dry cell, an alkaline battery, a lead acid battery, a nickel-cadmium battery, a nickel-hydrogen battery, a carbon-zinc battery, a fuel battery, a solar battery, or any combination of the above.

The electrochemical analysis and simulation device 100 of the present invention further comprises a transmission unit 50 electrically coupled to the processing unit 20 and configured to access the inspection result of the sample 91 through a personal computer or a notebook computer, or configured to write the executable program into the replaceable counting chip 11 through the personal computer or the notebook computer. The transmission unit 50 may be a wired transmission unit or a wireless transmission unit, and the transmission protocol of the wired transmission unit includes Universal Serial Bus (USB) or Electronic Industries Alliance (EIA) serial communication interface standards RS-232, RS-485, or any combination of the above, and the transmission protocol of the wireless transmission unit includes Wireless Fidelity (Wi-Fi), Worldwide Interoperability for Microwave Access (WiMAX), Bluetooth, Infrared Radiation (IR), Radio Frequency (RF), Zigbee, or any combination of the above.

The electrochemical analysis and simulation device 100 of the present invention further comprises a control unit 60 electrically coupled to the processing unit 20 and configured to control the processing unit 20 to capture the inspection signal of the sample 91 through the inspection unit 90 and then processing the signal. The control unit 60 may be a press key or a touch panel.

The electrochemical analysis and simulation device 100 of the present invention further comprises an indicating unit 70 electrically coupled to the processing unit 20 and/or the power supply unit 40 and configured to indicate a processing status of the inspection signal of the sample 91 processed by the processing unit 20, and/or indicate an electric power status of the power supply unit 40. The indicating unit 70 may be a light emitting diode (LED) or light emitting diodes (LEDs) with a different color for indicating a different status, and the invention is not limited to such arrangement only.

The electrochemical analysis and simulation device 100 of the present invention further comprises a storage unit 80 electrically coupled to the processing unit 20 and configured to store the inspection result generated by the processing unit 20. The storage unit 80 may be a Random Access Memory (RAM), a flash memory, a phase change memory, or any combination of the above.

The electrochemical analysis and simulation device 100 of the present invention further comprises an environmental sensing unit 110 electrically coupled to the processing unit 20 and configured to sense an environmental factor (including temperature, humidity, pressure, light intensity, oxygen content, pH value, salts content or any combination of the above), so that the processing unit 20 can correct the inspection signal of the sample 91 according to the environmental factor to generate the inspection result. In addition, the processing unit 20 may use the environmental factor sensed by the environmental sensing unit 110 to correct, change or compensate the voltage or current applied to the sample 91 in order to obtain a more accurate inspection result.

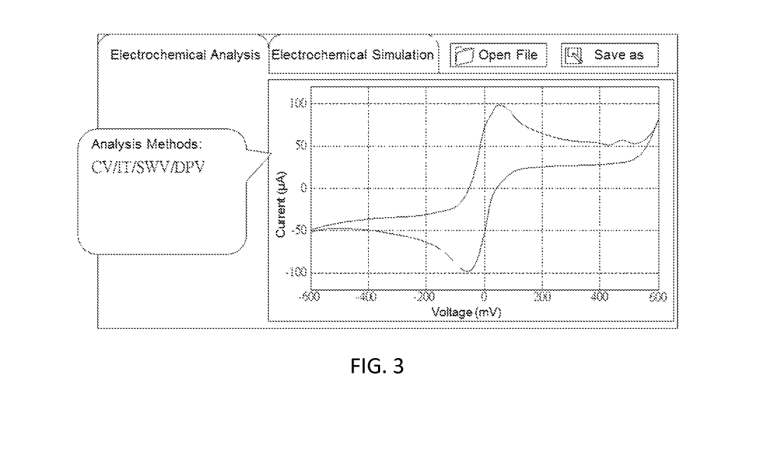

With reference to FIG. 3 for a schematic view of an interface of an electrochemical analysis and simulation device which is used as an electrochemical analyzer in accordance with a preferred embodiment of the present invention, a user may connect the electrochemical analysis and simulation device to a personal computer or a notebook computer via a wired transmission or a wireless transmission, so that a corresponding software program can be used to perform an electrochemical analysis such as Cyclic Voltammetry (CV), Amperometry (I-T Curve), Square-Wave Voltammetry (SWV), Differential Pulse Voltammetry (DPV), etc and display the inspection result and access the inspection result. However, the present invention is not limited to such arrangements only, and any electrochemical analysis is covered within the scope of the present invention.

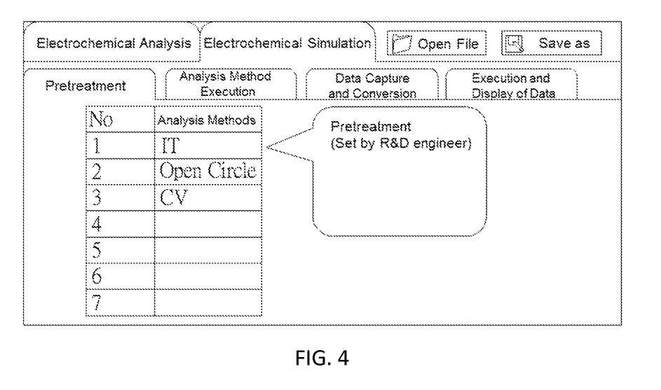

With reference to FIGS. 4 to 7 for the schematic views of the interfaces of an electrochemical analysis and simulation device which is used as an electrochemical simulator in accordance with a preferred embodiment of the present invention.

When the electrochemical analysis and simulation device of the present invention is used as an electrochemical simulator, an executable program may be pre-written into a replaceable counting chip, so that a user can operate the electrochemical analysis and simulation device 100 from a control unit of the electrochemical analysis and simulation device 100 to inspect various types of analytes. Therefore, the user may replace the replaceable counting chip according to different inspection requirements so as to improve flexibility of use significantly.

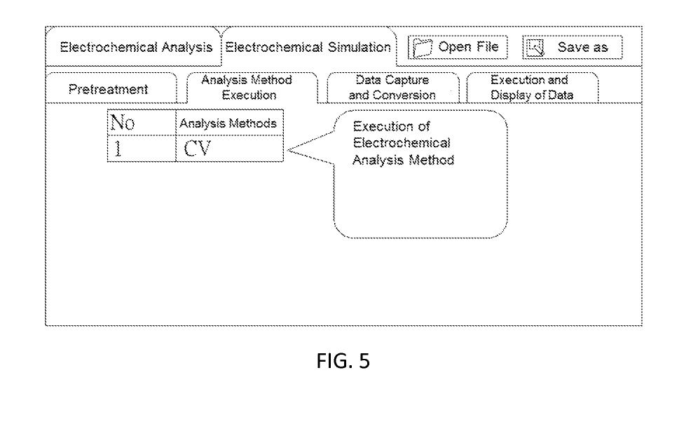

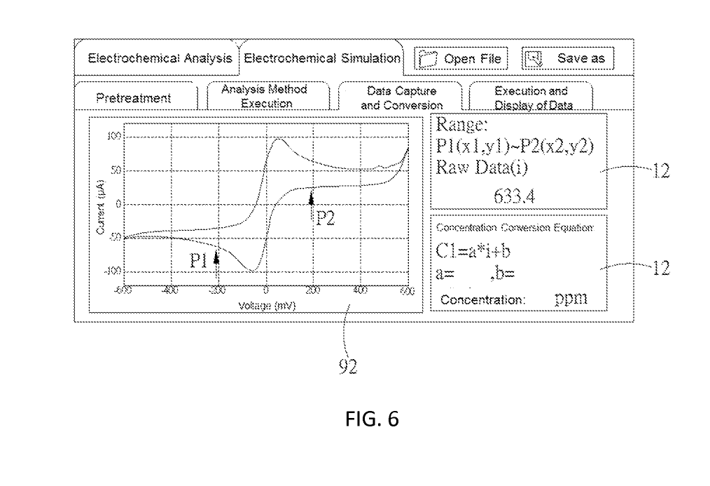

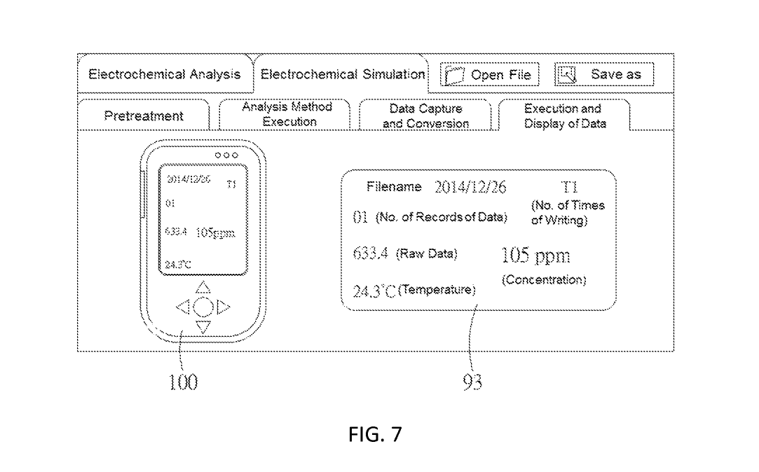

The executable program pre-written into the replaceable counting chip includes four programs, respectively: Pre-processing (as shown in FIG. 4), Execution of Analysis Method (as shown in FIG. 5), Capture and Conversion of Data (as shown in FIG. 6), and Execution and Display of Result (as shown in FIG. 7).

In the pre-processing program as shown in FIG. 4, a user or a R&D (research and development) engineer may use one or a combination of the electrochemical analysis methods including Cyclic Voltammetry (CV), Amperometry (I-T Curve), Square-Wave Voltammetry (SWV) and Differential Pulse Voltammetry (DPV) to determine the voltage applied to the sample or the voltage applying time.

In FIG. 5, the user may inspect the sample according to the selected electrochemical analysis method to capture an inspection signal 92 of the sample.

In FIG. 6, the user can set parameters 12 such as a range from P₁(x₁, y₁) to P₂(x₂, y₂) of a current-voltage curve of the captured inspection signal 92, and then performs a computation such as addition, subtraction, differentiation, integration, maximum value, and minimum value of the data within this range to obtain raw data, and then set parameters 12 of a conversion equation (such as a quadratic equation C₁=a*i+b) to convert the raw data into the inspection result 93 such as concentration of the analyte. However, the present invention is not limited to such arrangement only, any setting of the parameters 12 and conversion of data are covered within the scope of the claims of the present invention.

In FIG. 7, the inspection result 93 is displayed on the display unit of the electrochemical analysis and simulation device 100 after converting the raw data. The displayed inspection result 93 is a piece of information such as a filename, the number of times of writing, the number of records of data, raw data, and concentration and/or temperature. However, the present invention is not limited to the aforementioned inspection results.

After the user writes an edited executable program into a replaceable counting chip, the electrochemical analysis and simulation device 100 no longer needs to connect to a personal computer or a notebook computer, and the electrochemical analysis and simulation device 100 can execute an offline electrochemical simulation and display the inspection result 93 on the display unit of the electrochemical analysis analog device 100. Besides, the user may change the replaceable counting chip according to different inspection requirements such that flexibility of use can be improved significantly. Since the electrochemical analysis and simulation device 100 of the present invention has a small volume and thus can be carried easily and used as an electrochemical simulator for an offline electrochemical simulation.

While the invention has been described by means of specific embodiments, numerous modifications and variations could be made thereto by those skilled in the art without departing from the scope and spirit of the invention set forth in the claims.

What is claimed is:

1. An electrochemical analysis and simulation device, comprising:
an input unit configured to read an executable program pre-written into a replaceable counting chip;
a processing unit electrically coupled to the input unit and configured to process an inspection signal of a sample according to the executable program to generate an inspection result;
a display unit electrically coupled to the processing unit and configured to display the inspection result; and
a power supply unit electrically coupled to the processing unit and the display unit and configured to supply electric power required by the processing unit and the display unit.

2. The electrochemical analysis and simulation device of claim 1, further comprising a transmission unit electrically coupled to the processing unit and configured to access the inspection result.

3. The electrochemical analysis and simulation device of claim 2, wherein the transmission unit is a wired transmission unit or a wireless transmission unit.

4. The electrochemical analysis and simulation device of claim 1, further comprising a control unit electrically coupled to the processing unit and configured to control the processing unit to process the inspection signal of the sample.

5. The electrochemical analysis and simulation device of claim 1, further comprising an indicating unit electrically coupled to the processing unit and the power supply unit and configured to indicate a processing status of the inspection signal of the sample processed by the processing unit, and indicate an electric power status of the power supply unit.

6. The electrochemical analysis and simulation device of claim 1, further comprising a storage unit electrically coupled to the processing unit and configured to store the inspection result.

7. The electrochemical analysis and simulation device of claim 1, further comprising an inspection unit electrically coupled to the processing unit and configured to capture the inspection signal of the sample.

8. The electrochemical analysis and simulation device of claim 7, wherein the inspection unit is a three-electrode system or a multi-electrode system.

9. The electrochemical analysis and simulation device of claim 1, wherein the input unit is an information recognition device.

10. The electrochemical analysis and simulation device of claim 1, wherein the power supply unit is a battery, a power cable coupled to a mains power supply, or a cable shared with a signal transmission cable.

11. The electrochemical analysis and simulation device of claim 1, further comprising an environmental sensing unit electrically coupled to the processing unit and configured to sense an environmental factor, so that the processing unit may correct the inspection signal according to the environmental factor to generate the inspection result.

12. The electrochemical analysis and simulation device of claim 11, wherein the environmental factor includes temperature, humidity, pressure, light intensity, oxygen content, pH value, salts content or a combination thereof
